(19) United States
(12) Patent Application Publication
(10) Pub. No.: US 2026/0177228 A1
(43) Pub. Date: Jun. 25, 2026

(54) DUAL-WAVELENGTH RETICLE PROJECTION SYSTEM

(71) Applicant: RTK Holdings, LLC, Suffolk, VA (US)

(72) Inventor: Jeremy T. Kilgore, Suffolk, VA (US)

(73) Assignee: RTK Holdings, LLC, Suffolk, VA (US)

(21) Appl. No.: 19/428,906

(22) Filed: Dec. 22, 2025

Related U.S. Application Data
(60) Provisional application No. 63/736,827, filed on Dec. 20, 2024.

(51) Int. Cl. F21V 14/04; F21Y 113/13

(52) U.S. Cl. CPC F21V 14/04; F21Y 2113/13

(57) ABSTRACT

An illuminator comprising a body defining an illumination axis; a first light source and a second light source; a movable optical element movable between a first position in which light from the first light source is directed along the illumination axis, and a second position in which light from the second light source is directed along the illumination axis; and wherein the first and second light sources are different colors, and wherein the movable optical element is a mirror rotatable on a rotation axis perpendicular to the illumination axis and wherein each of the first and second light sources directs light toward the movable optical element along a respective light path perpendicular to the illumination axis.

### CROSS-REFERENCE TO RELATED APPLICATIONS

This application claims the benefit of U.S. Provisional Patent Application No. 63/736,827, filed on Dec. 20, 2024, entitled “DUAL-WAVELENGTH RETICLE PROJECTION SYSTEM”, which is hereby incorporated by reference in its entirety for all that is taught and disclosed therein.

### FIELD OF THE TECHNOLOGY

The present disclosure relates to firearms, namely weapon lights and sighting systems.

### BACKGROUND AND SUMMARY

In the fields of law enforcement, military operations, home defense, and professional shooting, there is an increasing demand for advanced sighting and targeting systems that offer versatility, precision, and adaptability in varied lighting conditions. Optical systems that integrate reticle projections, targeting sights, and illumination capabilities provide critical advantages in terms of situational awareness, fast target acquisition, and precise point of aim. As such, there has been development of weapon-mounted optics, which combine various light wavelengths to improve usability in both visible and infrared (IR) spectrums.

Traditional weapon lights and sighting systems often operate within a single wavelength—either visible light for general scenarios or infrared (IR) for low-visibility or night vision environments. This limitation presents significant challenges in situations where users need to quickly adapt to changing light environments or switch between visible and infrared modes for tactical purposes. In many devices, users face restrictions because switching between different lighting modes typically requires manual adjustments, mechanical switches, or the use of multiple devices, each suited for a specific wavelength. This adds time, complexity, and operational inefficiencies in critical, time-sensitive situations.

The above disadvantages are addressed by an illuminator comprising a body defining an illumination axis, a first light source and a second light source, a movable optical element movable between a first position in which light from the first light source is directed along the illumination axis, and a second position in which light from the second light source is directed along the illumination axis. Wherein, the first and second light sources are different colors, and wherein the movable optical element is a mirror rotatable on a rotation axis perpendicular to the illumination axis, and wherein each of the first and second light sources directs light toward the movable optical element along a respective light path perpendicular to the illumination axis.

### BRIEF DESCRIPTION OF THE DRAWINGS

FIG. 1 is a side view of an optical assembly comprised of a holder.

FIG. 2 is the same assembly depicted in FIG. 1, where the dowel and the mirror have been rotated to reflect the Infrared LED along the optical axis.

FIG. 3 is an alternate view of the assembly in FIGS. 1 and 2 that has been rotated 90 degrees.

FIG. 4 is an alternative view of the FIG. 3 assembly, inside of the body of the light and attached to a power supply by a spring terminal.

FIG. 5 is the method of zeroing the image of the gobo with an internal mechanism when the body is in a fixed position on the rail of the firearm held by in place by mounts.

FIG. 6 is a view which demonstrates how the set screws engage the holder with the opposing force of the detent spring, and how the optical assemble pivots with the ball and socket.

FIG. 7 is a view of an alternate method of zeroing the device, wherein the holder is in a fixed position to the body of the device.

FIG. 8 is a known mount, which is currently on the market, that could act as the second mount with the addition of a curvature in the aperture.

### DETAILED DESCRIPTION OF A PREFERRED EMBODIMENT

This disclosure introduces a rotating or movable mirror system that allows selective redirection of light from either a visible or IR LED, each mounted perpendicular to the optical axis and facing inward. By rotating the mirror to align with a specific LED, the system can instantly switch between visible and IR modes, directing the chosen wavelength along the optical axis, through the reticle, and into the imaging lens. This enables the operator to choose the illumination mode best suited for the conditions, enhancing operational flexibility and precision.

The disclosure addresses the limitations of existing sighting and illumination devices and provides a robust, adaptable solution tailored for the modern operator. By incorporating innovative light redirection techniques, controlled lens curvature, and dual wavelength functionality, this disclosure meets the complex demands of today's law enforcement, military, and home defense communities.

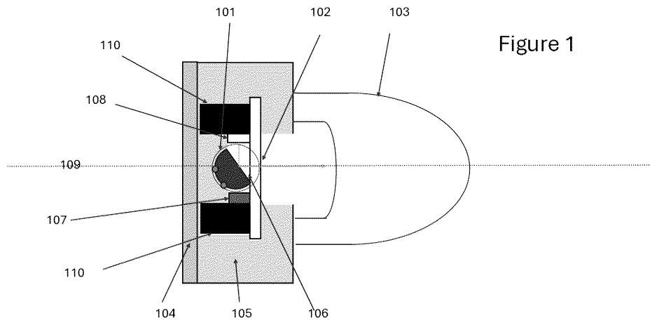

FIG. 1 is an optical assembly comprised of a holder (105) a PCB 104 with two 90 degree LED mounts (110) that are mounted in a configuration to point the White LED (108) and the Infrared LED (107) inward and from opposite sides toward the dowel (101) that extends to allow the user to rotate the mirror (106) attached to the dowel (101) to reflect the light from either LED at an 45 degree angle through the gobo (102) toward the imaging lens (103) and along the optical axis (109). FIG. 1 shows the mirror reflecting white light from the White LED (108) along the optical axis (109).

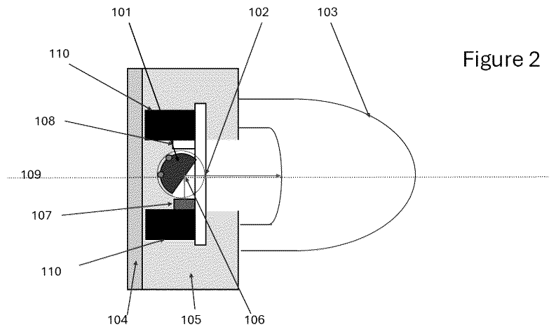

FIG. 2 is the same assembly where the dowel (101) and the mirror (106) have been rotated to reflect the Infrared LED (107) along the optical axis (109).

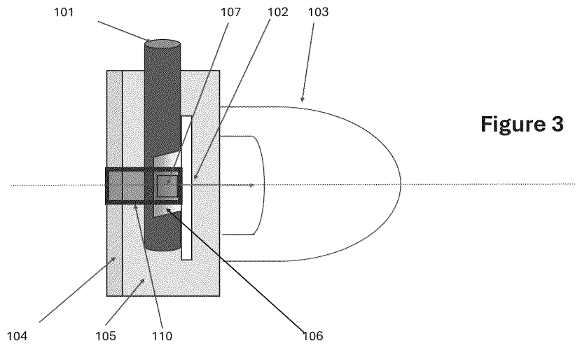

FIG. 3 is the same assembly with another view of the assembly that has been rotated 90 degrees from the view in FIG. 1 and FIG. 2.

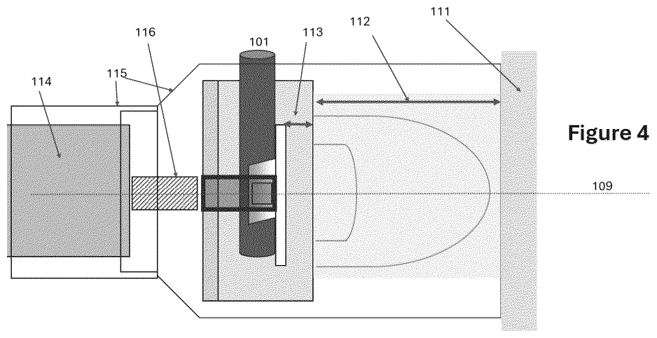

FIG. 4 is the FIG. 3 assembly inside of the body of the light (115) attached to a power supply (114) by a spring terminal (116). This also shows the dowel (101) extending outside of the body (115). Shown at the end of the body (115) is the focus adjust of the imaging lens (103) that moves the lens along the optical axis (109) the distance necessary (112) to focus the image of the gobo (102) into the distance. Likewise, the gobo (102) could also move the distance necessary (113) in relationship to the imaging lens (103) to focus the image of the gobo (102) into the distance.

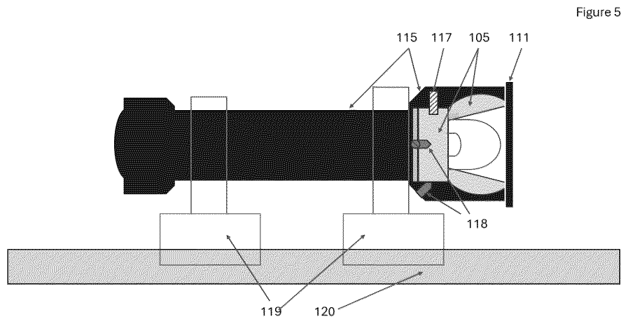

FIG. 5 is the method of zeroing the image of the gobo (102) with an internal mechanism when the body (115) is in a fixed position on the rail of the firearm (120) held by in place by mounts (119). In this diagram the holder (105) is designed to create a spherical form that pivots inside of the spherical socket of the body (115). This allows the optical assembly to move to accommodate windage and elevation. Windage and elevation is adjustable by using set screws (118) pushing against the opposing force of the detent spring (117) while pivots in the ball and socket mechanism made by the holder (105) and the body (115).

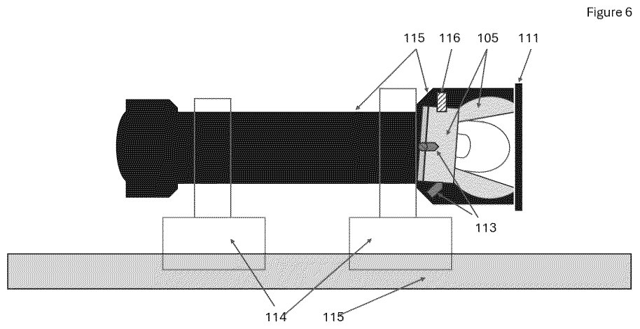

FIG. 6 demonstrates how the set screws (118) engage the holder (105) with the opposing force of the detent spring (117) and how the optical assemble pivots with the ball and socket.

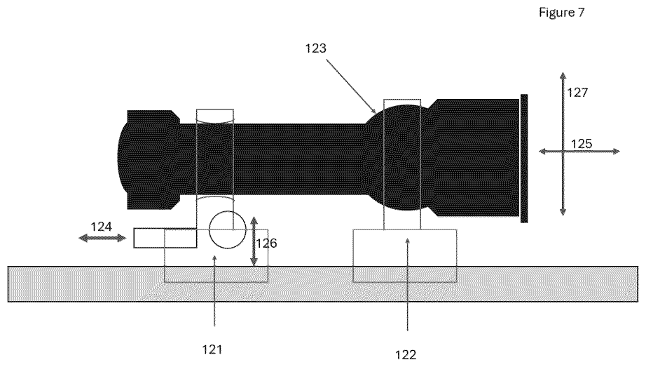

FIG. 7 is an alternate method of zeroing the device wherein the holder (105) is in a fixed position to the body (115) of the device. The body (115) consists of spherical design (123) on the outside along the body that pivots inside of a separate mount (122) that has the inverse spherical shape in the aperture of the mount (122). A second mount (121) with some curvature in the aperture that affixes along the body that is design to fit the curvature of the mount, with the mechanical ability to move the body in four directions using the first mount (122) as a pivot point for the body (115). The second mount (121) that has a side-to-side adjustment (124) causing the adjustment for windage (125), and an up and down adjustment (126) causing the adjustment for elevation (127).

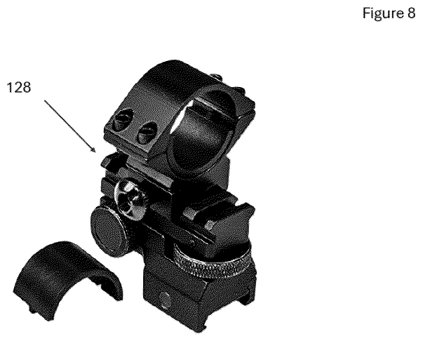

FIG. 8 is a known mount that is currently on the market that could act as the second mount (121) with the addition of a curvature in the aperture.

I claim:

1. An illuminator comprising:
a body defining an illumination axis;
a first light source and a second light source;
a movable optical element movable between a first position in which light from the first light source is directed along the illumination axis, and a second position in which light from the second light source is directed along the illumination axis; and
wherein the first and second light sources are different colors, and wherein the movable optical element is a mirror rotatable on a rotation axis perpendicular to the illumination axis and wherein each of the first and second light sources directs light toward the movable optical element along a respective light path perpendicular to the illumination axis.
